(19) United States
(12) Patent Application Publication
(10) Pub. No.: US 2015/0371281 A1
(43) Pub. Date: Dec. 24, 2015

(54) ADVERTISEMENT TRANSPARENCY

(71) Applicant: THOMSON LICENSING, Issy de Moulineaux (FR)

(72) Inventors: Ehud Weinsberg, Palo Alto, CA (US); Anmol Nalin Sheth, San Francisco, CA (US); Bin Liu, Sunnyvale, CA (US)

(21) Appl. No.: 14/709,831

(22) Filed: May 12, 2015

Related U.S. Application Data
(60) Provisional application No. 62/014,344, filed on Jun. 19, 2014.

(51) Int. Cl. G06Q 30/02

(52) U.S. Cl. CPC G06Q 30/0269

(57) ABSTRACT

A method of identifying targeted advertisement to provide advertisement transparency comprises receiving a set of content items having at least one advertisement element embedded within each of the content items and extracting the one or more advertisement element embedded within each of the content items. The method further includes determining a second content item associated with the advertisement element and a semantic category for the first content item and the second content item. The semantic categories of the first content item and the second content item are matched to determine if the advertisement is contextually related with the first content item.

### BACKGROUND

In recent years, online advertisers have attempted to improve the relevancy of advertisements (or “ads”) shown to users by profiling users' online interests and delivering ads relevant to those interests. Online trackers have become ubiquitous and cover a large fraction of a user's browsing behavior, enabling them to build comprehensive profiles of their online interests. This widespread tracking of users and the subsequent personalization of ads have received a great deal of negative feedback primarily because they lack insight into how their data is being collected and used. For example, consider a user that repeatedly receives ads about cures for a particularly private ailment. The user currently lacks a way to determine how advertisement targeting mechanisms are profiling her. Is it because the user's online interest profile matches the profile of users the advertiser is seeking to target? Is it because the websites that the user visits are contextually relevant to the ad and draw users that the advertiser is interested in targeting? Or, is it because the user actually tried to buy the particular medication online previously and the advertiser is re-marketing the product? Providing transparency into how users are profiled for target advertisements would lead to a new class of ad control mechanisms that enable end-users to exert fine-grained control over targeted advertising. Specifically, end-users would be able to block tracking along the actions related to specific ads, or indicate their ad preferences at a granularity that is not feasible via existing tools.

The primary challenge in providing transparency is to design mechanisms that account for the inherent complexity involved in ad delivery, including advertisers selecting from a variety of targeting mechanisms and multiple ad campaigns co-existing. Consequently, at any point, a webpage could contain ads from multiple campaigns that are targeting different aspects of the user's online interests. Furthermore, the ad selection process is based on a real-time auction, whose outcome also depends on financial parameters of the ad campaign like the cost per mille/thousand impressions (CPM) and desired click through rate (CTR).

Existing work seeking to address some of the transparency properties falls short in several ways. A common approach pushed forward by the industry is the AdChoices initiative and Google's ad preferences dashboard. These approaches provide the end-user visibility into their advertising profile and allow one to opt-out of certain “categories” across a few online trackers and ad networks. However, even with the limited participating entities, the mechanisms are not evenly implemented and often hard to use.

Various browser tools, such as Ghostery, AdBlock, NoScript and Collusion provide users visibility into the presence of third-party trackers on websites. However, these tools cannot determine the specific targeting mechanisms employed and consequently, only provide a very coarse grained control, by either turning off or on all ads and tracking. Policy proposals like Do Not Track provide a regulatory framework over the tracking and profiling of user data. However, in the present form, there is no legal mandate for the ad-networks to comply with this directive and this might require government intervention for universal enforcement.

Finally, a number of privacy preserving targeted advertising solutions have been proposed that aim to minimize the exposure of user data. Privad and Adnostic rely on local caching of ads and generation of the user profile, ObliviAd relies on a new secure processing hardware, and RePriv provides browser specific tools for third-parties to extract user profiles from the browser. However, these proposals require re-factoring large parts of the ad targeting ecosystem, hence making them difficult to deploy.

Therefore, there is a need for a mechanism that provides transparency into the targeted advertising ecosystem.

### SUMMARY

To address the challenges of targeted advertisement transparency, a method of identifying targeted advertisement is used. In one embodiment, the method includes a computing system receiving a set of content items having at least one advertisement element embedded within each of the content items and extracting the one or more advertisement element embedded within each of the content items. The method further includes determining a second content item associated with the advertisement element and a semantic category for the first content item and the second content item. The semantic categories of the first content item and the second content item are matched to determine if the advertisement is contextually related with the first content item.

In an embodiment, the method of identifying targeted advertisement is used to identify a domain that caused the advertisement element to be embedded within the content item. The method further comprises extracting the one or more advertisement element, wherein the advertisement element is a remarketing tag, and matching a domain associated with the second content item and the remarketing tag with a log of domains browsed by the user having embedded remarketing code in the web page source. The matching domain causing the advertisement to be embedded within the first content item can be displayed to the user.

In another embodiment, the method of identifying targeted advertisement is used to identify contextually targeted advertisements. The method comprises receiving by a computer system, a set of web pages having at least one advertisement element embedded within the set of web pages and extracting the one or more advertisement element. The method further comprises: determining a landing page associated with each of the extracted advertisement elements; determining at least one web page category for each of the web pages of the set of web pages; generating a model operable to relate the advertisement element with the associated set of web pages using a set of binary classifiers; and computing a targeting score corresponding to the advertisement associated with the set of web pages, the targeting score comprising the set of binary classifiers generated from the model, the targeting score determining if the advertisements are contextually associated with the set of web pages.

### BRIEF DESCRIPTION OF THE FIGURES

FIGS. 1A-1C illustrates example advertisements with the targeted advertisement characterizations in an example embodiment.

FIG. 2 illustrates a block diagram illustrating an embodiment a system for online ad transparency.

FIG. 3 illustrates a flow diagram illustrating a method of collecting measurements about display ads and identifying contextually targeted ads according to an embodiment.

FIG. 4 illustrates a flow diagram illustrating a method of collecting measurements about display ads and identifying behaviorally targeted ads according to an embodiment.

FIG. 5 illustrates a flow diagram illustrating a method of collecting measurements about display ads and identifying remarketed target ads according to an embodiment.

FIGS. 6A-C illustrates an example of a targeting ad analysis display.

### DETAILED DESCRIPTION

Described herein is a practical measurement and analysis framework that relies on end-user measurements to provide transparency into how online display ads (flash and image based ads) target users. In one embodiment, the measurement tool is a browser-based extension that provides detailed measurements of online display ads. The ads are characterized by three distinct targeting techniques: contextual targeting, behavioral targeting, and remarketed targeting. The analysis component uses a novel contextual model to predict the ad categories expected on a webpage in the absence of tracking to determine contextually targeted ads. A metric can be applied to quantify the extent to which the user is being behaviorally targeted. For remarketing based targeting, exact actions of the user's clickstream that led to the ad being targeted can be determined

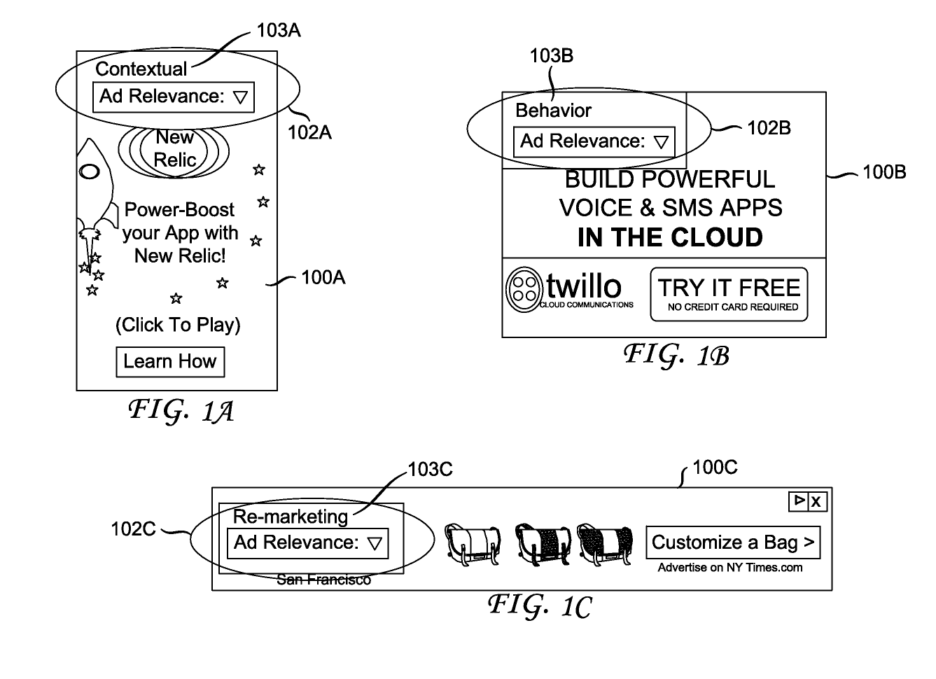

FIGS. 1A-1C illustrates example advertisements with the targeted advertisement characterizations. The user can be provided a webpage 100A, 100B, 100C comprising ads 102A, 102B, 102C augmented with a layer describing the characterized targeting of the ads 103A, 103B, 103C (contextual, behavioral, retargeting/re-marketing respectively). A selection of this layer enables a user to learn more information regarding the set of actions the user implemented by the user that led to the serving of the ad. Selection of this layer can comprise: selecting a hyperlink that can direct a user to preference setting page, selecting the augmented layer such that a drop down object is displayed, or hovering over the augmented layer such that a drop down object is displayed. The user preference setting page or the drop down object can allow a user to set preferences to block or filter certain ads. The user preference setting page can also provide the user a detailed analysis on the user's tracking, such as the category of the page and the history of the other web pages that relate to the ad. There are three primary targeting mechanisms (e.g., 103A, 103B, 103C) available to advertisers when setting up an ad campaign, namely contextual, re-marketing and behavioral targeting. The primary targeting mechanisms vary in the level of user information used while selecting an ad.

Contextual targeting, as illustrated in FIG. 1A, involves matching an ad with the context of the page that it is displayed on, and ignores the user's interest profile. The targeting is implicit: a car insurance company will place ads on auto-related sites because it is assumed that visitors to the site are likely to own a car and will need insurance. With contextual targeting, users having different profiles will broadly see the same kind of ads, and the ads will match the topic/context of the particular website (or a related category).

Behavioral Targeting, as illustrated in FIG. 1B, is used to select a few “related” ads from a very large ad catalog that is shown to the user. This filtering is done based on the user's interest profile and computed by the ad-network. The user's interest profile is determined by tracking the user's internet browsing activity over a long period of time. This mechanism goes beyond the “single domain” aspect of re-targeting, and selects ads that might relate to the user's long term online interests. With behavioral targeting, a user might see car insurance related ads on a site about food & nutrition simply because the user visited multiple different car insurance related websites. This form of targeting is controversial given that it relies on a detailed analysis of the user's online behavior, and results in ads that can be dissonant with the page being viewed.

Re-marketed targeting (or retargeting), as illustrated in FIG. 1C, is a very specific mechanism used by advertisers to target users who, in the past, have indicated a very specific interest in a particular product (e.g., visiting the product website and shops for said product). For example, when a user visits a car insurance site, clicks on a link to get a quote and leaves without finalizing it, the user's information can be used for remarketed targeting.

The insurance company (via the ad-network) can place re-marketing ads—e.g., insurance discounts—into other websites the user visits which can be unrelated to cars or insurance to lure the user back to finish the purchase. Here, the advertiser exploits a very narrow and explicit signal from the user to target ads.

While in one embodiment, contextual targeting, behavioral targeting and remarketed targeting are only used in characterizing ads, there are several other attributes and mechanisms that can be used for ad selection. For example, attributes, such as user geolocation, inferred demographics of website visitors, and browser/device identification can be used to characterize ads.

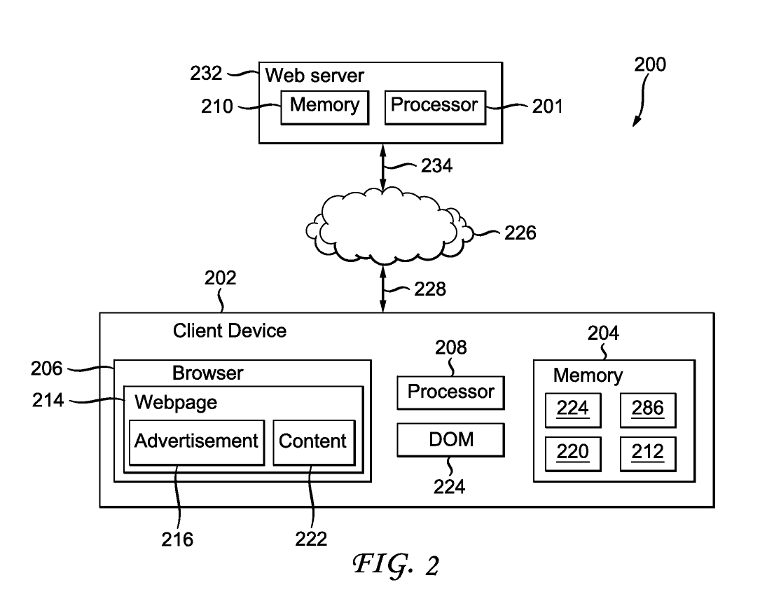

FIG. 2 illustrates a block diagram illustrating an embodiment of a system for online ad transparency 200. The system for online ad transparency includes a client 202 connected to a network 226 over connection 228. The client 202 can be any device that requests content from a web server. For example, the client 202 can be a portable digital assistant (PDA), a personal computer (PC), a portable communication device such as a cellular phone, or any other device that requests content from a server. In a non-limiting example, the network 226 can be a wide area network, such as the World Wide Web (WWW), a local area network (LAN), a wireless network, or any other network. The system for online ad transparency 200 also includes a web server 232 connected to the network 226 via connection 234. The web server can comprise a memory 210 and a processor 201. In one embodiment, the web server 232 accepts JIM requests from the client 202 serves web content, such as web pages 214. The web server 232 can be hardware (e.g., a computer) or software (e.g., computer application) that delivers web content that can be accessed through the network 226.

The client 202 can comprise a memory 204, a browser 206, a processor 208, and a document object model 224. The memory 204 provides storage for one or more a web pages, an exemplary one of which is illustrated at 214. The web page 214 can includes an identification tag. As described above, the identification tag allows the web page 214 to identify the type of advertisement or advertisements that are to be part of the web page 214. The client 202 also includes a browser 206. The browser 206 renders the web page 214, including an advertisement 216 according to a document object model 224. The document object model 224 defines the manner in which the web page 214 is rendered. The web page 214 also includes content 222, which can be, for example, text, images, or any other page content. As will be described more fully below, in an embodiment, the memory 204 can also include JavaScript software, a JavaScript Object Notation (JSON) object: 286 and a JavaScript library 220, which defines methods to insert ad creative into a document object model 224. The document object model 224 defines the web page 214. As will be more fully described below, the JavaScript software makes calls to the JavaScript library 212 that interprets the JSON object 286 to insert an advertisement in the page 214 that is rendered by the browser 206.

Detecting Contextually Targeted Ads

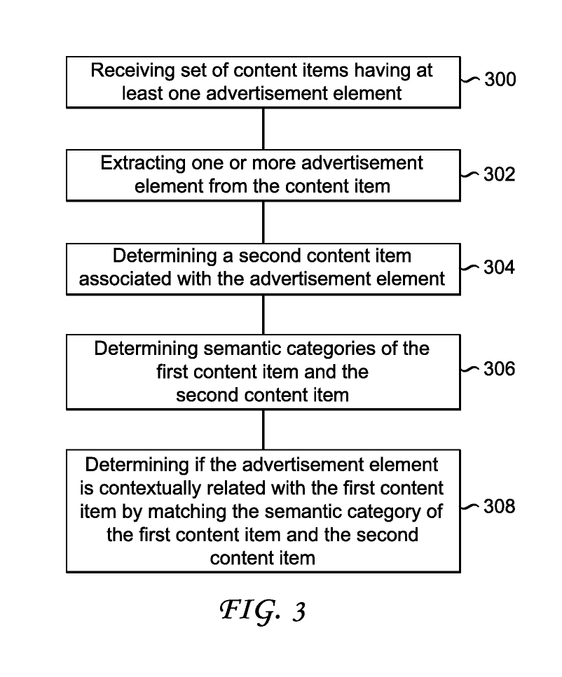

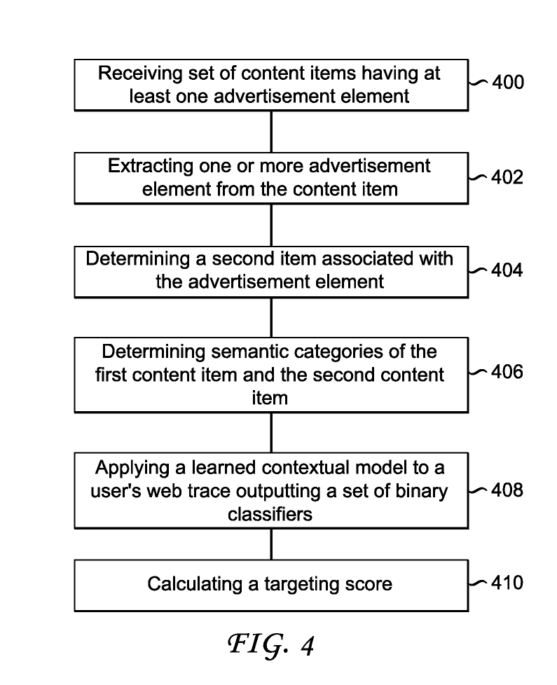

FIG. 3 illustrates a flow diagram for a method of collecting measurements about display ads and identifying contextually targeted ads according to an embodiment. Collecting measurements about display ads requires the ability to disassemble the elements of a webpage, identify ad elements and associate these with particular categories. Existing ad monitoring and blacklisting tools, such as AdBlock and Ghostery, work by matching URL patterns embedded in a webpage against a set of blacklist patterns, and cannot look deeper into the element and reason about it. The task is made even more difficult by complex document object model (DOM) structures, deep nesting of elements, and dynamic JavaScript execution, that are found on a large fraction of webpages on the Internet today. The method described herein, reliably extracts the ad elements of a page, identifies the actual landing pages for the ad-elements, and associates pages and the embedded ads with specific semantic categories.

At step 300, a set of content items having at least one advertisement element embedded within each of the content items is received. In one embodiment, the content item can be a web page. At step 302, one or more advertisement elements are extracted. In one embodiment, this module parses the (possibly complex) DOM structure of the webpage and extracts specific attributes of display ads that reveal the landing page for each of the ads. The landing page refers to the website that would be visited by clicking on the ad. Extracting the advertisement elements is complicated by the fact that display ads are often embedded in nested iFrame tags spanning multiple levels. Furthermore, the same origin policy enforced by modem web browsers permits an outer iFrame to inspect and communicate with its immediate inner iFrame only if the two iFrames are from the same domain. To address this, custom JavaScript code is recursively injected into all iFrames on the webpage and a dedicated background page is set up as a communication bridge between nested iFrames. This code reads the <href> or <flashvars> attributes for image or flash ads, and aggregates information at the background page running within the context of the browser plugin. This module also logs ad tracker elements, such as re-marketing scripts and cookies, on the webpage. Re-marketing scripts are detected by searching for the unique ad tracker JavaScript code. Ad tracking cookies are detected by monitoring outgoing HTTP requests and comparing against the publicly available patterns provided by services such as the Ghostery tracker database.

At step 304, a second content item associated with the advertisement element is determined. In one embodiment, a second content item can be a landing page. For each identified ad element, the landing page is inferred by parsing the value of the attributes extracted by the DOM parser module and searching for specific patterns in the URL, such as “adurl=” and “redirect url=”. At step 306, semantic categories of the first content item and the second content item are determined For example, the webpage “www.nfl.com” will be associated with the following semantic categories: sports, American and football, and the webpage “www.webmd.com/cancer” will be associated with the following semantic categories: health, medical conditions, cancer. A single page or ad landing page can be associated with more than one semantic category. In one embodiment, the semantic categories of the web page and the landing pages of all the display ad elements is determined by querying a content analysis API. The content analysis API analyzes content and identifies concepts or key words/phrases within the content. Additionally, the content analysis API can tag or categorize the content. The content analysis API can be publicly available, such as Yahoo! Content Analysis API.

At step 308, a determination is made as to whether the advertisement element is contextually related with the first content item by matching the semantic category of the first content item and the second content item. In one embodiment, a contextual model is used to determine if an advertisement is contextually related to the webpage. For a given page that matches a set of web page categories, the model outputs a for 0 for each ad-category, which is a prediction on whether an ad of that category should appear on that web page. If the prediction of an ad appearance holds (output=1), then the ad-categories conform to the trained model, and the targeting is contextual. In another embodiment, the contextual model used to determine a contextual association between advertisement and a webpage can be a machine learning model. In a specific embodiment, the model learns by logistic regression with L1 regularization. The model learns a set of coefficients which weigh the relevance of each (input) page category to the (output) ad category. The L1 regularization enforces a sparse model, wherein only a few coefficients will be non-zero as most webpages are mapped to only a few categories Importantly, the learned classifier model also outputs a confidence score over the classification results, and can utilize this information to account for noise inherent in the data being modeled.

The models can be trained on either a tracking dataset or a no-tracking dataset. The tracking dataset uses an empty user profile wherein all cookies are cleared and visits the webpages using default browser settings. The user's cookies, cache pages, and track histories are taken into consideration. This allows the model to take into account ads that target the interest profile of the user over the pages visited previously. The no-tracking dataset uses a blank user profile, wherein cookies, cache pages and track histories are not taken into consideration. The no-tracking dataset offers a view of what kinds of ads would have been selected if the ad-network had no information about the user. This allows the model the functionality to predict the ad categories that can appear on a webpage. This model can be applied on users in the tracking dataset which provides a reason about how the user is being tracked by comparing predictions against the ads being loaded. The contextual model trained on a no-tracking dataset has some inherent noise, such as differences across ad campaigns for the same category and inherent dynamic of ad auctions and campaigns. These serve to weaken the association between webpage categories and the predicted contextual ad category. The noise reduces the confidence of the classifier for the two output classes, resulting in the distribution of confidence overlapping. Thus, in one embodiment, only samples whose classification confidence is above a certain threshold are considered.

To characterize the model generated using the above described approach, an Area Under the Curve (AUC) score is computed and the model parameters are inspected. The AUC score can range from a 0.0 representing a random ad placement to a 1.0 representing a perfect precision and recall advertisement placement. AUC scores typically range from 0.5 (random) to 1 (perfect precision and recall). In an example across 81 ad categories, the median AUC score is 0.71. 10% of the ad categories had an AUC score above 0.85 (e.g. American Football, Travel Transportation and Disease & Medical Conditions) and 9% of the ad categories had an AUC score below 0.6 (e.g. Credit, Gaming and Lottery).

TABLE 1
Model trained for a few ad categories. The second column enumerates
the set of most influential page categories, and third column denotes the
AUC metric for the model.

| Ad Category | Associated Webpage Categories | AUC |
|---|---|---|
| Parenting | Parenting, Arts and Crafts, Family Health, | .83 |
| | Holidays and Celebrations, Education, | |
| | Cultural Groups | |
| Celebrities | Skin Care, Arts and Entertainment, Real | .77 |
| | estate, Autos, Certificates | |
| Health | Health, Nutrition, Insurance, Disease and | .75 |
| | Medical Conditions, Athletics Track and | |
| | Field, Parenting | |
| Financial Fraud | Employment and Career, Finance, Credit | .70 |
| Prevention | | |
| Credit | Finance, Arts and Entertainment events, | .59 |
| | Credit, Travel organizations, Real estate, | |
| | Shopping | |

Detecting Behaviorally Targeted Ads

FIG. 4 illustrates a flow diagram illustrating a method of collecting measurements about display ads and identifying behaviorally targeted ads according to an embodiment. At step 400, a set of content items having at least one advertisement element embedded within each of the content items is received. In one embodiment, the content item can be a web page. At step 402, one or more advertisement elements are extracted. At step 404, a second content item associated with the advertisement element is determined At step 406, semantic categories of the first content item and the second content item are determined. At step 408, a learned contextual model is applied to a user's web trace outputting a set of binary classifiers to relate an ad category to its associated webpages categories. At set 410, a targeting score is calculated to indicate to what extent to which the contextual model correctly predicts ads on the webpages visited by the user.

Applying the learned contextual model to a user's web trace (tracking dataset), two cases are considered in each webpage instance: (i) the true-positive case (TP), which validates the classifier prediction and indicates that the ad was selected purely based on the page context, and (ii) the false negative case (FN), where the where the prediction is in-correct, indicating that the ad was selected based on factors beyond the context of the page (i.e., which the model completely accounts for). The other two cases, true negatives and false positives, are not strong indicators of the ad selection being contextual. Putting these together, a false negative rate (FNR) is denoted and computed for a set of pages. In an embodiment, the FNR=FN/(FN+TP) and can be used as the targeting score. When FNR is close to 0, ads placed on the page indicates the ads are contextually targeted, and values close to 1 indicate that the ads are behaviorally targeted.

Detecting Re-Marketing Ads

Re-marketing ad campaigns require advertisers to tag different pages on their sites with specific JavaScript code generated by the ad platform. This allows the advertiser to distinguish users that reach different parts of their site, and customize the advertising strategies accordingly. For example, a re-marketing ad can display ads for travel tickets to a specific destination based on the fare search the user performed. Hence, re-marketing campaigns ignore the user profile and “follow” the user on the web, re-marketing the product to convince the user to come back to the advertiser's webpage. In one embodiment, the method for identifying targeted advertisement monitors and logs all domains visited by a user that have embed JavaScript remarketing code in the page source. Subsequently, for every ad, the domain of the ad landing page is matched against the set of domains containing the remarketing scripts. When the two match, the exact pages in the user's clickstream that caused the specific ad to be targeted can be determined. This enables the user to learn about how their particular actions in the past resulted in the current ad being displayed.

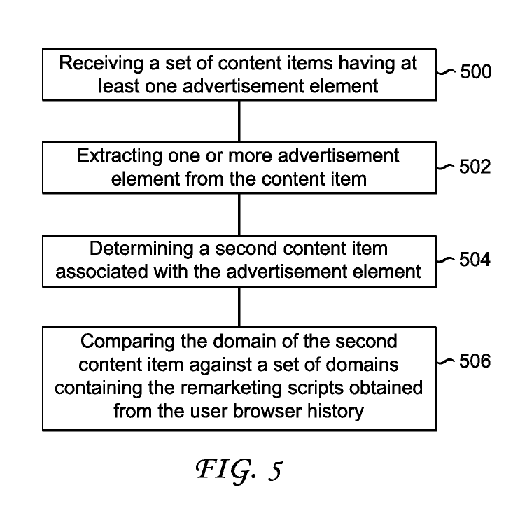

FIG. 5 illustrates a flow diagram for a method of collecting measurements about display ads and identifying remarketed target ads according to an embodiment. At step 500, a set of content items having at least one advertisement element embedded within each of the content items is received. In one embodiment, the content item can be a web page. At step 502, one or more advertisement elements are extracted. In one embodiment, the advertisement element is an embed JavaScript remarketing code in the page source. At step 504, a second content item associated with the advertisement element is determined At step 506, the domain of the second content item is compared against the set of domains containing the remarketing scripts obtained from the user's browsing history.

Targeting Ad Analysis Display

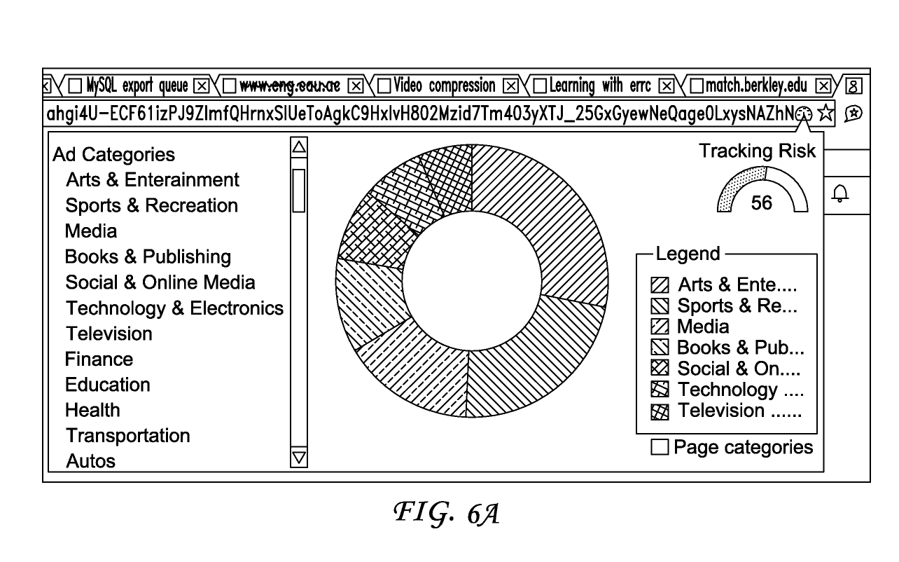

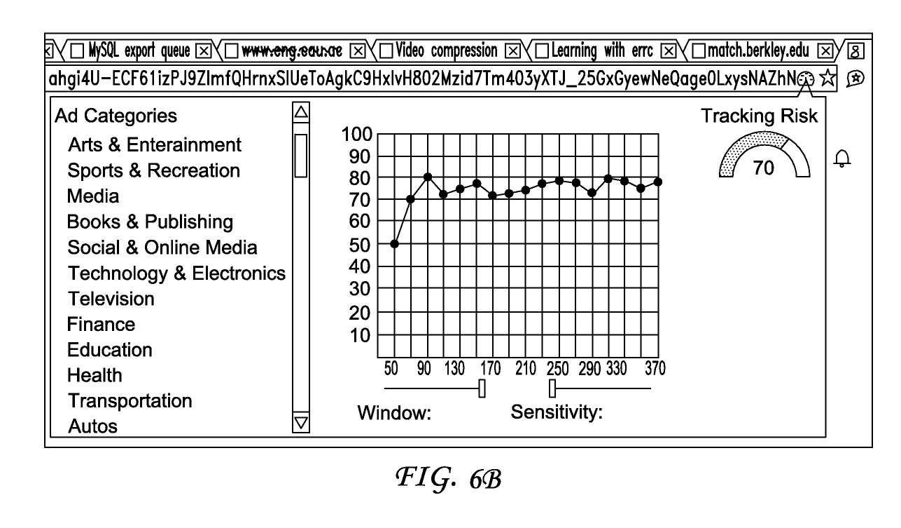

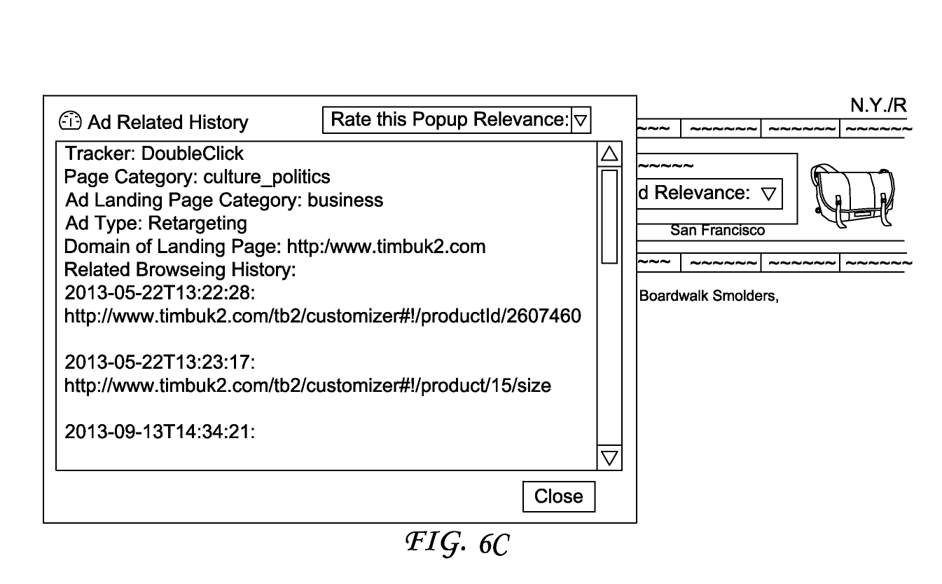

FIGS. 6A-6C illustrate examples of targeting ad analysis displays. The display can include a graphical representation of how the ads were target, FIG. 6A, and the rate at which the ads targeted, FIG. 6B. The graphical representation can comprise a bar graph, circle graph, picture graph, histogram, line graph or the like. The display can show the category of the page and the history of the other web pages that are related to the ad, FIG. 6C.

In the case of a remarketed ad, the display can provide information relating to the tracker, page category, ad landing page, ad type, domain of the landing page, and related browsing history, including the date and time the website was visited. The representation can further disseminate information regarding how much of the user's profile is being used to serve targeted ads, denoted as a tracking or privacy risk.

According to the inventive principles as disclosed in connection with the preferred embodiment and other embodiments, the invention and the inventive principles are not limited to any particular kind of user device, but can be used with any general purpose computing device having networking capabilities, as would be known to one of ordinary skill in the art, arranged to perform the functions described and the method steps described.

In an embodiment of the present invention, some or all of the method components are implemented as a computer executable code. Such a computer executable code contains a plurality of computer instructions that when performed in a predefined order result with the execution of the tasks disclosed herein. Such computer executable code can be available as source code or in object code, and can be further comprised as part of, for example, a portable memory device or downloaded from the Internet, or embodied on a program storage unit or computer readable medium. The principles of the present invention can be implemented as a combination of hardware and software and because some of the constituent system components and methods depicted in the accompanying drawings can be implemented in software, the actual connections between the system components or the process function blocks can differ depending upon the manner in which the present invention is programmed.

The computer executable code can be uploaded to, and executed by, a machine comprising any suitable architecture. Preferably, the machine is implemented on a computer platform having hardware such as one or more central processing units (“CPU”), a random access memory (“RAM”), and input/output interfaces. The computer platform can also include an operating system and microinstruction code. The various processes and functions described herein can be either part of the microinstruction code or part of the button program, or any combination thereof, which can be executed by a CPU, whether or not such computer or processor is explicitly shown. In addition, various other peripheral units can be connected to the computer platform such as an additional data storage unit and a printing unit.

The functions of the various elements shown in the figures can be provided through the use of dedicated hardware as well as hardware capable of executing appropriate software. When provided by a processor, the functions can be provided by a single dedicated processor, by a single shared processor, or by a plurality of individual processors, some of which can be shared. Explicit use of the term “processor” or “controller” should not be construed to refer exclusively to hardware capable of executing software, and can implicitly include, without limitation, digital signal processor hardware, ROM, RAM, and non-volatile storage. Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is intended that such equivalents include both currently known equivalents as well as equivalents developed in the future, i.e., any elements developed that perform the same function, regardless of structure.

The present invention is described in the foregoing examples, which are set forth to aid in the understanding of the invention, and should not be construed to limit in any way the scope of the invention as defined in the claims which follow hereafter. While the foregoing has been described in some detail for purposes of clarity and understanding, it will be appreciated by one skilled in the art, from a reading of the disclosure that various changes in form and detail can be made without departing from the true scope of the invention.

1. A computer implemented method for identifying contextually targeted advertisements, comprising:
receiving a set of content items having at least one advertisement element embedded within each of the content items;
extracting the one or more advertisement element;
determining a second content item associated with the advertisement element;
determining a semantic category for the first content item and the second content item; and
determining if the advertisement is contextually related with the first content item by matching the semantic category of the first content item and the second content item.

2. The method of claim 1, wherein the advertisement element is a re-marketing tag.

3. The method of claim 2, further comprising:
matching a domain associated with the second content item with a log of domains associated with a set of webpages browsed by the user, wherein the webpages have embedded re-marketing code; and
displaying the matching domain causing the advertisement element to be embedded within the first content item.

4. The method of claim 1, wherein the advertisement element is an attribute of the targeted advertisement revealing the second item.

5. The method of claim 4, wherein a contextual model is configured to match the semantic category of the first content item and the second content item using a set of binary classifiers.

6. The method of claim 5, further comprising:
computing a targeting score corresponding to the advertisements associated with the set of webpages, the targeting score comprising the set of binary classifiers generated from the model, the targeting score determining if the advertisement are behaviorally associated with the set of webpages.

7. The method of claim 1, wherein the first content item is a webpage requested by the user.

8. The method of claim 7, wherein the second content item is a landing webpage for the advertisement element.

9. The method of claim 8, wherein extracting the one or more advertisement element comprises recursively injecting a custom JavaScript code into an iFrame on the webpage and setting up a dedicated background page as a communication bridge between nested iFrames.

10. The method of claim 9, wherein the background page aggregates the advertisement attributes.

11. A method for identifying targeted advertisements, comprising:
receiving a set of webpages having at least one advertisement element embedded within the set of webpages;
extracting the one or more advertisement elements;
determining a landing page associated with each of the extracted advertisement elements;
determining at least one webpage category for each of the web pages of the set, and at least one advertisement category for each of the landing pages;
generating a model configured to relate the advertisement element with the associated set of webpages using a set of binary classifiers; and
computing a targeting score corresponding to the advertisements associated with the set of webpages, the targeting score comprising the set of binary classifiers generated from the model, the targeting score determining if the advertisement are contextually associated with the set of webpages.

12. The method of claim 11, further comprising adding an augmented layer presenting the characterization of the advertisement.

13. The method of claim 11, further comprising displaying one or more characterization of the advertisement.

14. The method of claim 13, further comprising displaying at least one of the following: a page category, an advertisement landing page category, a characterization of the advertisement, a domain of the landing page, and a related browsing history.

15. The method of claim 11, further comprising displaying an aggregate tracking risk, wherein the aggregate tracking risk includes a metric that indicates how much of the user's profile is being used to serve targeted advertisements.

16. The method of claim 15, further comprising displaying a graphical representation of how the aggregated tracking risk evolves over time.

17. A non-transitory computer readable media comprising program code that when executed by a programmable processor causes the processor to execute a method for identifying contextually targeted advertisements, the computer readable media comprising:
a program code receiving a set of content items having at least one advertisement element embedded within each of the content items;
a program code extracting the one or more advertisement element;
a program code determining a second content item associated with the advertisement element;
a program code determining a semantic category for the first content item and the second content item; and
a program code determining if the advertisement is contextually related with the first content item by matching the semantic category of the first content item and the second content item.

18. The program code of claim 17, wherein the advertisement element is a remarketing tag.

19. The program code of claim 18, further comprising:
a program code matching a domain associated with the second content item with a log of domains associated with a set of webpages browsed by the user, wherein the webpages have embedded remarketing code; and
displaying the matching domain causing the advertisement element to be embedded within the first content item.

20. The program code of claim 17, wherein the advertisement element is an attribute of the targeted advertisement revealing the second item.

21. The program code of claim 20, wherein a contextual model is configured to match the semantic category of the first content item and the second content item using a set of binary classifiers.
